(19) United States
(12) Patent Application Publication
(10) Pub. No.: US 2025/0004497 A1
(43) Pub. Date: Jan. 2, 2025

(54) Tablet Protective Case and Tablet Keyboard Kit

(71) Applicant: GALASTAR LIMITED, Shenzhen (CN)

(72) Inventor: Poyu Chen, Shenzhen (CN)

(21) Appl. No.: 18/695,970

(22) PCT Filed: Oct. 28, 2022
(86) PCT No.: PCT/CN2022/128310

§ 371 Date: Mar. 27, 2024

(30) Foreign Application Priority Data
Nov. 2, 2021 (CN) 202122677644.2
Oct. 14, 2022 (CN) 202222723147.6

(51) Int. Cl. G06F 1/16; G06F 3/02

(52) U.S. Cl. CPC G06F 1/16; G06F 3/0202

(57) ABSTRACT

A tablet protective case including a back plate, three edge plates respectively connected to three side edges of the back plate, a conductive needle, an integrated keyboard, and a fixing cover plate; one of the side surfaces of the tablet is exposed to be in contact with the integrated keyboard, the back plate is provided with a connection hole and a sink groove, and a circumference of the conductive needle extends radially outward to form a skirt portion, an end of the conductive needle is inserted into the connection hole and configured for conducting with a conductive portion arranged on a back of the tablet, the skirt portion is located in the sink groove, and an other end of the conductive needle penetrates through the fixing cover plate, and the fixing cover plate is fixedly covered on the skirt portion and the back plate.

### CROSS-REFERENCE TO RELATED APPLICATIONS

This application is the United States national phase of International Patent Application No. PCT/CN2022/128310, filed Oct. 28, 2022, and claims priorities to Chinese Patent Application No. 202122677644.2, filed Nov. 2, 2021 and Chinese Patent Application No. 202222723147.6, filed Oct. 14, 2022; the disclosures of which are hereby incorporated by reference in their entireties.

### BACKGROUND

### 1. Technical Field

The present disclosure relates to technical field of terminal accessories, and more particularly to a tablet protective case and a tablet keyboard kit.

### 2. Technical Description

In order to expand the functionality of the tablets and facilitate quick input by users, Apple Inc. has launched a keyboard stand that can be used in conjunction with the iPads. The keyboard stand includes a magnetic support plate fixed on the back of the iPad and a keyboard that is foldable and connected to the support plate. The support plate and the keyboard can also be folded to form a support structure allowing the iPad to be tilted, such that the keyboard can be placed in front of the screen of the iPad, it is convenient for typing input.

However, the keyboard stand currently used in conjunction with the iPad cannot effectively wrap around the side surfaces of the iPad, resulting in scratches when used in conjunction with the keyboard stand. More importantly, if the keyboard stand is frequently used, it is not possible to use an iPad protective shell separately, or every time it is used in conjunction with the keyboard stand, the iPad protective shell is needed to be removed firstly and then the iPad is mounted to the keyboard stand. As a result, the iPad lacks protection during daily use or requires frequent disassembly and assembly of the protective shell.

### SUMMARY

Accordingly, provided are an improved tablet protective case and tablet keyboard kit, which address the technical deficiencies in the existing technology, where tablets need to be used in conjunction with keyboard stand, resulting in the lack of protective measures or frequent disassembly of protective shell during daily use.

Non-limiting embodiments or aspects of the present disclosure adopt the technical solutions are as following:

In a first non-limiting embodiment or aspect, a tablet protective case is provided, which is configured for wrapping a tablet and configured for being sandwiched between the tablet and a support plate of an integrated keyboard when in use, and the tablet protective case includes: a back plate; three edge plates, respectively connected to three side edges of the back plate; a conductive needle, configured for conducting the tablet and the integrated keyboard; and a fixing cover plate; in which the back plate and the three edge plates are respectively configured for wrapping a back surface and side surfaces of the tablet, such that one of the side surfaces of the tablet is exposed to be in contact with the integrated keyboard; the back plate is provided with a connection hole and a sink groove arranged at a circumference of the connection hole, and a circumference of the conductive needle extends radially outward to form a skirt portion, an end of the conductive needle is inserted into the connection hole and configured for conducting with a conductive portion arranged on a back of the tablet, the skirt portion is located in the sink groove, and an other end of the conductive needle penetrates through the fixing cover plate, and the fixing cover plate is fixedly covered on the skirt portion and the back plate.

In a non-limiting embodiment or aspect, the fixing cover plate is ultrasonically connected or pasted to the back plate.

In a non-limiting embodiment or aspect, the back plate includes a base plate and a decorative plate that are laminated, a side of the base plate facing away from the decorative plate is configured for closely fit with the tablet, the decorative plate is provided with an accommodating hole for accommodating the fixing cover plate, the sink groove and the connection hole are arranged on the base plate, and the sink groove and the connection hole are located in an area defined by the accommodating hole.

In a non-limiting embodiment or aspect, the base plate and the decorative plate are integrally formed; or alternatively the base plate and the decorative plate are separately formed and fixedly connected.

In a non-limiting embodiment or aspect, the conductive needle includes a first conductive end and a second conductive end respectively located on two sides of the skirt portion; the fixing cover plate is provided with an avoidance hole, the first conductive end is arranged to be inserted into the connection hole, the second conductive end is arranged to be extended into the avoidance hole, and an end of the second conductive end away from the skirt portion is arranged flush with a side of the fixing cover plate.

In a non-limiting embodiment or aspect, the first conductive end is connected with the connection hole in interference fit.

In a non-limiting embodiment or aspect, a diameter of the first conductive end is less than a diameter of the second conductive end.

In a non-limiting embodiment or aspect, one of the edge plates is provided with a receiving groove for receiving a stylus.

In a non-limiting embodiment or aspect, a bottom of the receiving groove is provided with an access hole to facilitate removing the stylus.

In a non-limiting embodiment or aspect, the tablet protective case further includes soft protective corners detachably connected to the edge plates, an end of one of the edge plates is provided with an accommodating groove and an insertion hole that are in communicated with each other, the accommodating groove is arranged along a length direction of one edge plate, one of the soft protective corners comprises an insertion portion configured for matching with the accommodating groove and a corner protective portion configured for matching with the insertion hole, the insertion portion and the corner protective portion are interconnected, the corner protective portion is protruded on an outer wall the edge plate, and a cross-sectional area of the insertion portion perpendicular to the length direction of the edge plate is greater than a cross-sectional area of the corner protective portion perpendicular to the length direction of the edge plate.

In a non-limiting embodiment or aspect, the insertion portion includes an arc unit and strip units that are interconnected, the corner protective portion is connected with the arc unit, and a length direction of the strip units is parallel to the length direction of the edge plate.

In a non-limiting embodiment or aspect, the edge plate is provided with a key hole at a key right facing a mobile terminal, one of the strip units is configured to directly arrange facing the key, the strip unit is provided with a pressing hole penetrating through two sides of the insertion portion along a pressing direction of the key, the pressing hole is arranged facing the key hole, and an inner wall of the pressing hole is elastically connected with a pressing portion.

In a non-limiting embodiment or aspect, two sides of the pressing portion are connected to the inner wall of the pressing hole by elastic walls.

In a non-limiting embodiment or aspect, a side of the insertion portion is provided with a plurality of hollow portions.

In a non-limiting embodiment or aspect, a first step surface is formed at a joint of the corner protective portion and the insertion portion, a second step positioning surface is formed at joint of the insertion hole and the accommodating groove, and the first step surface and the second step surface are arranged to be abutted against each other.

In a non-limiting embodiment or aspect, a portion where the corner protective portion is connected with the insertion portion is a root of the corner protective portion, a side of the corner protective portion away from the insertion portion is a top of the corner protective portion, and the corner protective portion gradually increases in size from the root to the top.

In a non-limiting embodiment or aspect, an inner portion of the corner protective portion is hollow.

In a non-limiting embodiment or aspect, the corner protective portion and the insertion portion are integrally formed.

In a non-limiting embodiment or aspect, one of the edge plates is provided with a receiving groove for receiving a stylus, and two ends of the edge plate are detachably connected with the soft protective corners.

In a second non-limiting embodiment or aspect, a tablet keyboard kit, which includes the tablet protective case described above and an integrated keyboard; the tablet protective case and the integrated keyboard are magnetically connected, and the integrated keyboard is mutually conductive to the tablet through a conductive needle.

The beneficial effects of the tablet protective case and tablet keyboard kit provided in the non-limiting embodiments or aspects of the present disclosure are summarized as follows: the tablet protective case includes a back plate, three edge plates, a conductive needle, and a fixing cover plate. The back plate and three edge plates are wrapped around the back and the side surfaces of the tablet, so as to wrap the tablet during daily use to protect the tablet. One side of the tablet is exposed for easy magnetic suction coordination with the integrated keyboard, so as to ensure normal typing on the keyboard. When the tablet is used in conjunction with an integrated keyboard, the two ends of the conductive needle are respectively conductive to a conductive portion on the back of the tablet and a conductive portion on the support plate of the integrated keyboard, so as to achieve conductivity between the tablet and the integrated keyboard. In order to prevent the conductive needle from falling off, one end of the conductive needle is inserted into the connection hole of the back plate, and the fixing cover plate is also covered and fixed on the skirt portion and back plate, so that the skirt portion is sandwiched between the back plate and the fixing cover plate, the possibility of the conductive needle falling off is reduced.

### BRIEF-DESCRIPTION OF THE DRAWINGS

In order to explain the non-limiting embodiments or aspects of the present disclosure more clearly, a brief introduction regarding the accompanying drawings that need to be used for describing the non-limiting embodiments or aspects of the present disclosure or the prior art is given below; it is obvious that the accompanying drawings described as follows are only some non-limiting embodiments or aspects of the present disclosure, for those skilled in the art, other drawings can also be obtained according to the current drawings on the premise of paying no creative labor.

FIG. 1 is an explosive structural view of a tablet protective case and a tablet provided in a non-limiting embodiment or aspect or aspect of the present disclosure;

FIG. 2 is a first three-dimensional structural view of a tablet protective case provided in a non-limiting embodiment or aspect of the present disclosure;

FIG. 3 is a second three-dimensional structural view of a tablet protective case provided in a non-limiting embodiment or aspect of the present disclosure;

FIG. 4 is an explosive structural view of a tablet protective case provided in a non-limiting embodiment or aspect of the present disclosure at an area of a conductive needle;

FIG. 5 is a cross-sectional view of a tablet protective case provided in a non-limiting embodiment or aspect of the present disclosure at an area of a conductive needle;

FIG. 6 is a third three-dimensional structural view of a tablet protective case provided in a non-limiting embodiment or aspect of the present disclosure;

FIG. 7 is a cross-sectional view of a tablet protective case provided in a a non-limiting embodiment or aspect of the present disclosure at an area of an edge plate;

FIG. 8 is a first three-dimensional structural view of a soft protective corner provided in a non-limiting embodiment or aspect of the present disclosure; and

FIG. 9 is a second three-dimensional structural view of a soft protective corner provided in a non-limiting embodiment or aspect of the present disclosure.

### DETAILED DESCRIPTION

In order to make the purpose, the technical solution and the advantages of the present disclosure be clearer and more understandable, the present disclosure will be further described in detail below with reference to accompanying figures and non-limiting embodiment or aspects. It should be understood that the specific non-limiting embodiment or aspects described herein are merely intended to illustrate but not to limit the disclosure.

It is noted that when a component is referred to as being “fixed to” or “disposed on” another component, it can be directly or indirectly on another component. When a component is referred to as being “connected to” another component, it can be directly or indirectly connected to another component. Terms such as “up”, “down”, “left”, “right”, and so on are the directions or location relationships shown in the accompanying figures, which are only intended to describe the present disclosure conveniently and simplify the description, but not to indicate or imply that an indicated device or component must have specific locations or be constructed and manipulated according to specific locations; therefore, these terms shouldn't be considered as any limitation to the present disclosure. Terms “the first” and “the second” are only used in describe purposes, and should not be considered as indicating or implying any relative importance, or impliedly indicating the number of indicated technical features; and “a plurality of” means two or more, unless there is additional explicit and specific limitation.

In order to illustrate the technical solutions provided in the present disclosure, the following are detailed in conjunction with specific drawings and non-limiting embodiments or aspects.

The tablet protective case 1 provided in the non-limiting embodiments or aspects of the present disclosure is described. The tablet protective case 1 protects the tablet 2 during daily use. When the tablet 2 needs to be used with an integrated keyboard, the integrated keyboard can be mounted directly on the back of the tablet protective case 1 without removing the tablet protective case 1. The integrated keyboard can be an original intelligent keyboard, a wonderful control keyboard, a keyboard type intelligent double-sided clip, etc. of Apple Inc.

In a non-limiting embodiment or aspect of the present disclosure, the tablet 2 is provided with a tablet protective case 1, and when used with an integrated keyboard, the tablet protective case 1 is sandwiched between the tablet 2 and the integrated keyboard, and the integrated keyboard can be removed when the integrated keyboard is not used, in which case the tablet protective case 1 can still protect the tablet 2.

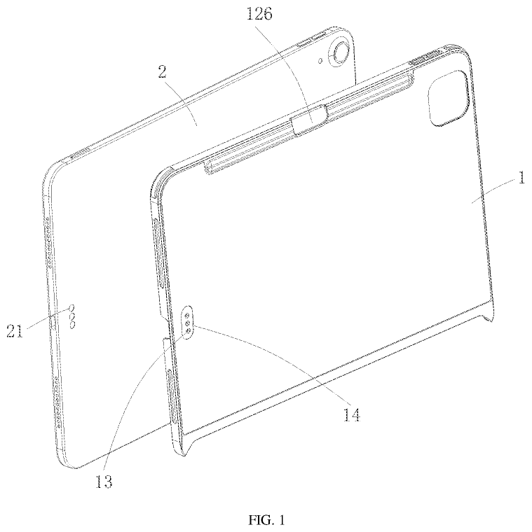

As shown in FIGS. 1 to 3, the tablet protective case 1 includes a back plate 11, three edge plates 12, a conductive needle 13, and a fixing cover plate 14. The three edge plates 12 are respectively connected to the three sides of the back plate 11, the back plate 11 is used to wrap the back of the tablet protective case 1, and the three edge plates 12 are respectively used to wrap the side surfaces of the tablet protective case 1. One side surface of the tablet 2 is exposed, so that when the tablet 2 is used with the integrated keyboard, the exposed side surface of the tablet 2 is arranged towards the keyboard and magnetized with the keyboard to ensure the communication connection between the integrated keyboard and the tablet 2, so as to ensure the typing input of the keyboard.

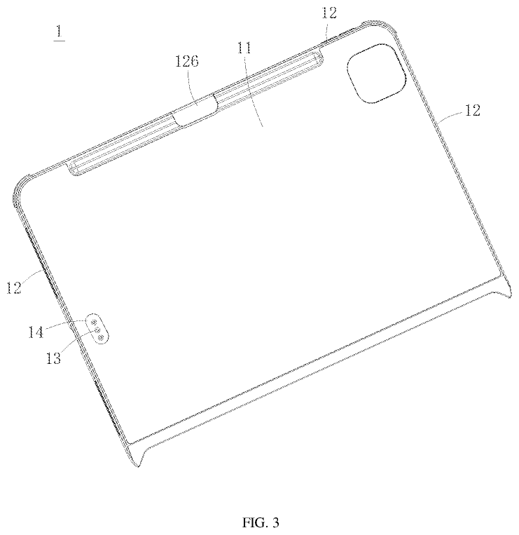

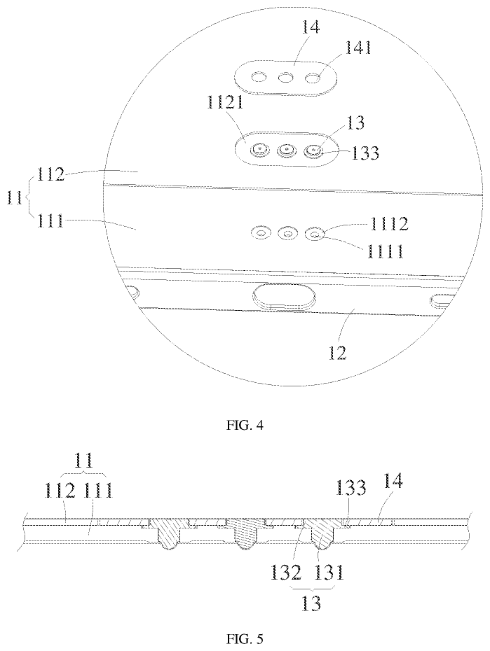

As shown in FIG. 4 and FIG. 5, a conductive portion 21 is arranged on the back of the tablet 2, a conductive portion 21 is also arranged on the support plate of the integrated keyboard, a connection hole 1111 is arranged on the back plate 11, and a sink groove 1112 is also arranged at the a circumference of the connection hole 1111, and one end of the conductive needle 13 penetrates through the connection hole 1111 and is conductive to the conductive portion 21 of the tablet 2. The other end of the conductive needle 13 is in contact with the conductive portion 21 of the support plate of the integrated keyboard, so that the conductive needle 13 is arranged so that the tablet 2 can be in contact with the integrated keyboard when the tablet protective case 1 is mounted. A skirt portion 133 is formed radially outward at the circumference of the conductive needle 13, and when one end of the conductive needle 13 is inserted into the connection hole 1111, the skirt portion 133 is located in the sink groove 1112, so that one side of the skirt portion 133 is arranged flush with the back plate 11. The conductive needle 13 penetrates the fixing cover plate 14, and the fixing cover plate 14 is covered and fixed on the skirt portion 133 and the back plate 11, so that the skirt portion 133 is sandwiched between the fixing cover plate 14 and the back plate 11, thus preventing the conductive needle 13 from falling off during prolonged use.

The tablet protective case 1 in non-limiting embodiment or aspects includes a back plate 11, three edge plates 12, a conductive needle 13 and a fixing cover plate 14, and the back plate 11 and three edge plates 12 are wrapped around the back and the side surfaces of the tablet 2, which is wrapped around the tablet 2 during daily use to form protection for the tablet 2, and one side surface of the tablet 2 is exposed, it is convenient for magnetic suction coordination with the integrated keyboard to ensure the normal typing input of the keyboard. When the tablet 2 is used with the integrated keyboard, both ends of the conductive needle 13 are respectively conductive to the conductive portion 21 on the back of the tablet 2 and the conductive portion 21 on the support plate of the integrated keyboard to realize the conductivity between the tablet 2 and the integrated keyboard. In order to prevent the conductive needle 13 from falling off, one end of the conductive needle 13 is inserted into the connection hole 1111 of the back plate 11, and the fixing cover plate 14 is covered and fixed on the skirt portion 133 and the back plate 11, so that the skirt portion 133 is sandwiched between the back plate 11 and the fixing cover plate 14, and the possibility of the conductive needle 13 falling off is reduced.

In a non-limiting embodiment or aspect of the present disclosure, as shown in FIG. 5, the fixing cover plate 14 is ultrasonically connected to the back plate 11, through which the surfaces of the fixing cover plate 14 and the back plate 11 in contact with each other can be fused together and form a whole. Therefore, the fixing cover plate 14 and the back plate 11 are integrated, and the possibility of the fixing cover plate 14 falling off is smaller, and the possibility of the conductive needle 13 falling off is smaller. In non-limiting embodiments or aspects, the fixing cover plate 14 and back plate 11 can also be fixed by pasting a double-sided tape, a liquid glue, etc., which has lower cost and wider applicability.

In the embodiment, when the tablet protective case 1 is mounted, one end of the conductive needle 13 is firstly inserted into the connection hole 1111, the bottom wall of the skirt portion 133 and the bottom wall of the sink groove 1112 are in contact with each other, and the bottom wall of the skirt portion 133 and the bottom wall of the sink groove 1112 are pasted to be fixed; then the fixing cover plate 14 is covered on partial surfaces of the skirt portion 133 and the back plate 11, so that the fixing cover plate 14 and back plate 11 are ultrasonically fixed or pasted to form a tablet protective case 1. The connection between the fixing cover plate 14 and the skirt portion 133 can also be fixed by pasting.

In a non-limiting embodiment or aspect of the present disclosure, as shown in FIGS. 4 and 5, the back plate 11 includes a base plate 111 and a decorative plate 112 that are laminated, the base plate 111 and the decorative plate 112 are fixed to each other. When the tablet protective case 1 is mounted on the tablet 2, one side of the base plate 111 is attached to the back of the tablet 2, and the other side of the base plate 111 is fixed to the decorative plate 112. The decorative plate 112 is provided with an accommodating hole 1121 for accommodating the fixing cover plate 14. The sink groove 1112 and the connection hole 1111 are arranged on the base plate 111, and the sink groove 1112 and the connection hole 1111 are located in an area defined by the accommodating hole 1121; that is, the sink groove 1112 and the connection hole 1111 are able to be exposed through the accommodating hole 1121. The number of connection holes 1111 in the accommodating hole 1121 can be multiple, and each connection hole 1111 is provided with one conductive needle 13. The fixing cover plate 14 can be contained in the accommodating hole 1121 by providing the base plate 111 and the decorative plate 112, and the decorative plate 112 provided with the accommodating hole 1121, the side of the fixing cover plate 14 facing away from the back plate 11 is arranged flush with the side of the decorative plate 112 facing away from the back plate 11, so as to smooth the surface of the tablet protective case 1.

In the embodiment, the base plate 111 and the decorative plate 112 are integrally formed, that is, the accommodating hole 1121 is directly arranged on the back plate 11, so that the fixing cover plate 14 is located in the accommodating hole 1121, the processing is simpler and the assembly steps can be reduced. Alternatively, the base plate 111 and the decorative plate 112 are formed separately, but the base plate 111 and the decorative plate 112 are fixed and connected after being formed separately, and can be fixed to each other by bonding.

In a non-limiting embodiment or aspect of the present disclosure, as shown in FIG. 5, the conductive needle 13 includes a first conductive end 131 and a second conductive end 132, the first conductive end 131 and the second conductive end 132 are respectively located on two sides of the skirt portion 133, and the first conductive end 131 is inserted into the connection hole 1111 of the back plate 11. The second conductive end 132 penetrates through the fixing cover plate 14, and the fixing cover plate 14 is provided with an avoidance hole 141 configured for the second conductive end 132 to pass through. The end of the second conductive end 132 away from the skirt portion 133 is arranged flush with the end of the fixing cover plate 14 away from the skirt portion 133 so that the surface of the tablet protective housing 1 is kept flat.

The first conductive end 131 can be built-in with a spring and other components, so that the first conductive end 131 can be flexibly connected to the back of the tablet 2 to ensure that the first conductive end 131 and the conductive portion 21 of the tablet 2 are always in conductive contact. The second conductive end 132 is in contact with the conductive portion 21 on the support plate of the integrated keyboard. Thus, the tablet 2 and the integrated keyboard can be electrically connected through the conductive needle 13.

In the embodiment, the conductive needle 13 is the pin needle.

In the embodiment, the first conductive end 131 and connection hole 1111 are interference fit, that is, the first conductive end 131 and connection hole 1111 are tightly connected, and will not fall from the back plate 11 after the conductive needle 13 is inserted into the back plate 11. At the same time, the conductive needle 13 is fixed by the fixing the cover 14, and the connection between the conductive needle 13 and the back plate 11 is further strengthened, and the possibility of the conductive needle 13 falling off is further reduced.

In the embodiment, the diameter of the first conductive end 131 is less than the diameter of the second conductive end 132. Since the second conductive end 132 is conductive contact with the integrated keyboard, the second conductive end 132 is arranged larger to increase the conduction area between the second conductive end 132 and the integrated keyboard, and even if the two are slightly staggered, the mutual conduction between the second conductive end 132 and the integrated keyboard can be ensured.

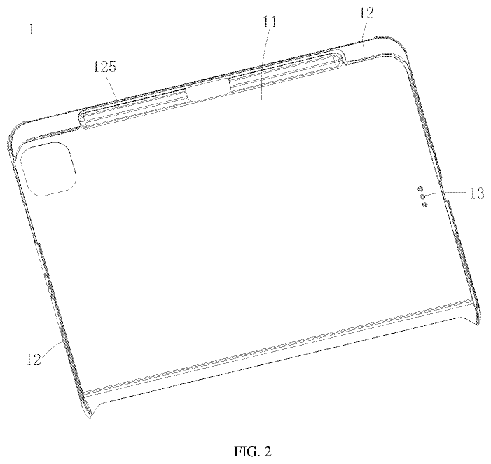

In a non-limiting embodiment or aspect of the present disclosure, as shown in FIG. 2, one of the edge plates 12 is provided with a receiving groove 125 for receiving a stylus, and the stylus is used to write on the tablet 2 to facilitate the user to record information. The opening of the receiving groove 125 can be arranged forward, that is, the orientation of the opening of the receiving groove 125 is the same as the screen of the tablet 2, for easy access. The tablet 2 is provided with a magnet at the receiving groove 125, so that the stylus can be stably held in the tablet protective case 1. The receiving groove 125 is arranged to receive the stylus, so as to prevent the loss of the stylus and for the user to develop good habits.

In the embodiment, the edge plate 12 provided with the receiving groove 125 can be arranged on the upper side of the tablet 2 or on the left and right sides of the tablet 2, and the lower side of the tablet 2 is exposed to fit with the keyboard.

In the embodiment, as shown in FIG. 3, a bottom of the receiving groove 125 is provided with an access hole 126, and the access hole 126 penetrates through the bottom wall of the receiving groove 125. In this way, when the stylus needs to be taken out, the stylus can be pushed out from the bottom of the receiving groove 125 through the access hole 126, without the need to pick out the stylus from the top of the receiving groove 125, which is more convenient for users to take out the stylus.

In a non-limiting embodiment or aspect of the present disclosure, the back plate 11 is provided therein with a magnet, such that a more convenient detachable connection is formed between the tablet protective case 1 and the integrated keyboard, and the accuracy of the positioning to each other can be ensured.

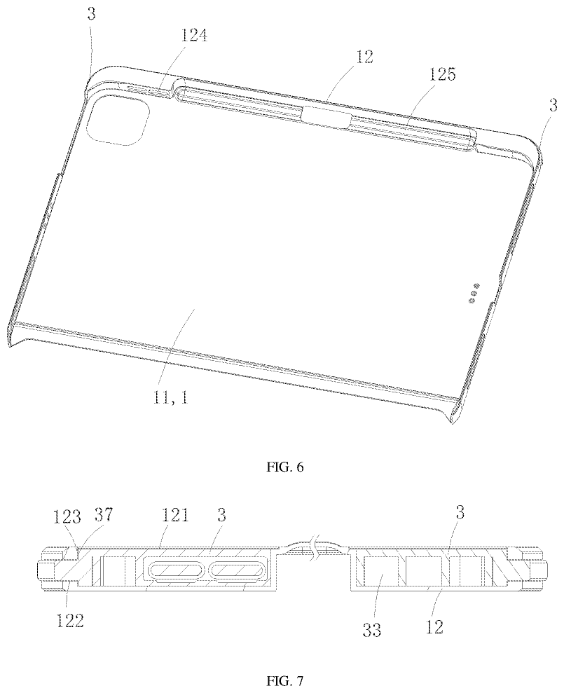

As shown in FIGS. 6 to 8, the tablet protective case further includes soft protective corners 3. The soft protective corners 3 has a certain elastic deformation ability, and the soft protective corners 3 are detachably connected with the edge plates 12, and the soft protective corners 3 can be assembled or disassembled according to the need of the user, which provides the user with more selectivity.

The end of the edge plate 12 is provided with an accommodating groove 121 and an insertion hole 122, and the accommodating groove 121 is communicated with the insertion hole 122, and the accommodating groove 121 is located inside the edge plate 12, and the insertion hole 122 is arranged to communicate the accommodating groove 121 and external side of the edge plate 12. Moreover, the length direction of the accommodating groove 121 is parallel to the length direction of the edge plate 12, that is, the accommodating groove 121 extends from the insertion hole 122 along the length direction of the edge plate 12. The soft protective corner 3 includes an insertion portion 31 and a corner protective portion 32, the insertion portion 31 is matched with the accommodating groove 121, the insertion portion 31 is configured to be arranged in the accommodating groove 121; the corner protective portion 32 is matched with the insertion hole 122, and the corner protective portion 32 is configured to be inserted in the insertion hole 122. It should be noted that part of the corner protective portion 32 is located in the insertion hole 122, and the other part of the corner protective portion 32 protrudes from the outer wall of the tablet protective case 1, so that when the mobile terminal falls, the corner protective portion 32 first contacts the ground to cushion the impact on the mobile terminal.

The cross-sectional area of the insertion portion 31 in a direction perpendicular to the length direction of the edge plate 12 is S1, and the cross-sectional area of the corner protective portion 32 in a direction perpendicular to the length direction of the edge plate 12 is S2, and S1 is greater than S2. Accordingly, the cross-sectional area of the accommodating groove 121 in a direction perpendicular to the length direction of the edge plate 12 is greater than the cross-sectional area of the insertion hole 122 in a direction perpendicular to the length direction of the edge plate 12. Thus, the joint of the insertion hole 122 and the accommodating groove 121 can limit the insertion portion 31 to prevent the insertion portion 31 from falling out of the accommodating groove 121 along the length direction of the edge plate 12.

Specifically, when assembling the soft protective corner 3, the insertion portion 31 of the soft protective corner 3 is inserted into the insertion hole 122. The insertion portion 31 will be stressed and deformed during assembly until the insertion portion 31 is completely inserted into the accommodating groove 121, and the soft protective corner 32 is located in the insertion hole 122. When removing the corner protector plug 3, the corner protector plug 3 can be pulled out of as a whole by directly holding the part of the soft protective corner 32 protruding from the tablet protective case 1.

In the embodiment, one end of the edge plate 12 is provided with the accommodating groove 121 and the insertion hole 122, that is, the end of the edge plate 12 can be mounted with the soft protective corner 3, or the two ends of the edge plate 12 are respectively provided with the accommodating groove 121 and the insertion hole 122, that is, the two ends of the edge plate 12 can be respectively mounted with one soft protective corner 3.

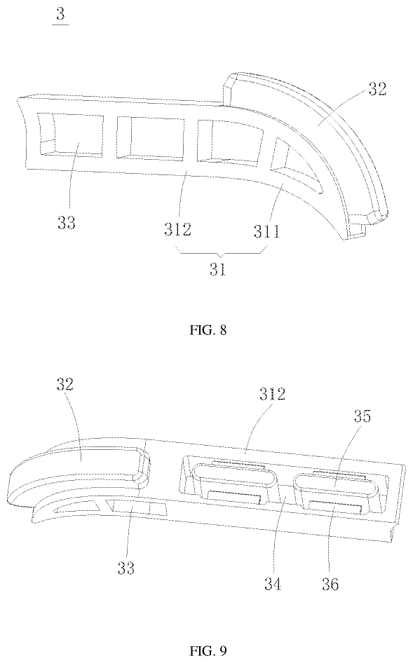

In a non-limiting embodiment or aspect of the present disclosure, as shown in FIGS. 8 and 9, the insertion portion 31 includes an arc unit 311 and strip units 312 that are in communicated with each other, the corner protective portion 32 is connected to the arc unit 311, the corner protective portion 32 is further arranged in an arc, and the corner protective portion 32 is arranged on the side of the arc unit 311 away from the strip units 312. The corner protective portion 32 and the arc unit 311 are arranged in an arc. When the corner guard soft plug 3 is mounted on the edge plate 12, the corner protective portion 32 and arc unit 311 are located at the corner of the tablet protective case 1, that is, at the end of the edge plate 12. The shape of the arc structure is the same as that of the corner of the mobile terminal. Thus, the shape structure of the tablet protective case is less different from that of the mobile terminal.

In a non-limiting embodiment or aspect of the present disclosure, as shown in FIGS. 6, 7, and 9, the edge plate 12 is provided with a key hole 124 at the key right facing the mobile terminal, through which the key protrudes a tablet protective case 1. After each soft protective corner 3 is mounted in the tablet protective case 1, the strip units 312 of one soft protective corner 3 are used to be arranged right facing the key of the mobile terminal. The strip unit 312 is provided with a pressing hole 34, the pressing hole 34 penetrates through the opposite sides of the strip unit 312 along the pressing direction of the key, and pressing hole 34 is arranged opposite to the key hole 124, so that the key is exposed, which is convenient to press and control the key. The inner wall of the pressing hole 34 is elastically connected with a pressing portion 35, the pressing portion 35 is arranged directly against the key hole 124. Since one side of the pressing portion 35 faces the key hole 124 and the other side is exposed, when the mobile terminal is mounted in the tablet protective case 1, the user can press the pressing portion 35 to contact the key and control the key. In the embodiment, the soft protective corner 3 is combined with the key portion, so that when the key is close to the end of the edge plate 12, the key can be controlled by the soft protective corner 3 in the embodiment.

When the number of the key is one, the size of pressing hole 34 and key hole 124 can be the same. When the number of the keys is multiple, the keys are arranged next to each other, the number of the pressing holes 34 can be one or more, and the number of the pressing holes 124 can be one or more.

In a non-limiting embodiment or aspect, as shown in FIG. 9, two sides of the pressing portion 35 are connected to the inner wall of the pressing hole 34 by elastic walls 36, so that the pressing portion 35 can move in a pressing direction of the key. When the pressing portion 35 is pressed by an external force, the elastic walls 36 are extended or expanded, so that the pressing portion 35 contacts the key. When the external force disappears, the elastic walls 36 rebound or fold, and the position of the pressing portion 35 returns to the initial state. The elastic walls 36 can be made of elastic material, such as a silicone, a rubber, etc., the elastic walls 36 can be clastic thin walls, so that the pressing portion 35 is subjected to less resistance when moving, that is, the pressing pressure is smaller and the pressing feel is better.

In a non-limiting embodiment or aspect of the present disclosure, as shown in FIGS. 8 and 9, a side of the insertion portion 31 is provided with a hollow portion 33. Withe providing of the hollow portion 33, on one hand, the deformation ability of the insertion portion 31 is stronger, so that the insertion portion 31 can easily deform and pass through the insertion hole 122; on other hand, the insertion portion 31 require less raw materials, injection molding will be easier, and it is not easy to appear pores and so on. The number of hollow portions 33 can be selected into multiple, so that the side of the insertion portion 31 forms a plurality of dividing ribs. The shape of the hollow portion 33 is not limited here, and can be selected as round, square, etc. The hollow portion 33 can be a hollow hole penetrating through the insertion portion 31, or a hollow groove.

In a non-limiting embodiment or aspect of the present disclosure, as shown in FIG. 7, a first step surface 37 is formed at the joint of the corner protective portion 32 and the insertion portion 31, and a second step surface 123 is formed at the joint of the insertion hole 122 and the accommodating groove 121. When the soft protective corner 3 is inserted into the edge plate 12, the first step surface 37 and the second step surface 123 are facing each other. When the soft protective corner 3 has a tendency to slide off the tablet protection shell 1, the first step surface 37 and the second step surface 123 are abutted against each other, so that the insertion portion 31 cannot slide off the tablet protection shell 1 under the restriction of the second step surface 123 and without the external force.

In non-limiting embodiment or aspects, the joint of the corner protective portion 32 and the insertion portion 31 is smoothly arranged, and the joint of the insertion hole 122 and the accommodating groove 121 is smoothly arranged. The soft protective corner 3 in the embodiment is relatively easy to be mounted and removed, and correspondingly, is more likely to falling off.

In a non-limiting embodiment or aspect of the present disclosure, as shown in FIGS. 8 and 9, the portion where the corner protective portion 32 is connected with the insertion portion 31 is the root of the corner protective portion 32, the side of the corner protective portion 32 away from the insertion portion 31 is the top of the corner protective portion 32, and the area of the corner protective portion 32 gradually increases from the root to the top. Thus, the top area of the corner protective portion 32 is greater than the area of the insertion hole 122, so that the corner protective portion 32 can shield the edge of the insertion hole 122, the dust deposition is reduced, and is can also prevent the corner protective portion 32 from shaking in the insertion hole 122.

In a non-limiting embodiment or aspect of the present disclosure, the inner portion of the corner protective portion 32 is hollow, such that an air bag is formed in the inner portion of the corner protective portion 32. When the soft protective corner 3 is impacted, it has a large buffer space and will not exert a large force on the mobile terminal, which is more conducive to protecting the mobile terminal. In particular, the corner protective portion 32 can be arranged in a closed manner and an air bag is formed within it. Alternatively, an opening is provided at the joint of the arc unit 311 and the corner protective portion 32, and the inter portion of the corner protective portion 32 is formed with an air bag cavity having the opening.

In a non-limiting embodiment or aspect of the present disclosure, the corner protective portion 32 and the insertion portion 31 are integrally formed, for example, the corner protective portion 32 and the insertion portion 31 are molded together by injection molding, the molding method is relatively simple and the processing cost is low.

In one embodiment of the present disclosure, one of the edge plates 12 is provided with a receiving groove 125 for receiving the stylus. Optionally, two ends of the edge plate 12 are respectively provided with the accommodating groove 121 and the insertion hole 122, so that two ends of the edge plate 12 can be detachably connected with the soft protective corner 3.

The present disclosure further provides a tablet keyboard kit, which includes a tablet protective case 1 in any of the above non-limiting embodiment or aspects. The tablet keyboard kit also includes an integrated keyboard that is detachably connected to the tablet protective case 1 and the integrated keyboard is in contract with the tablet protective case 1, and the integrated keyboard is kept in conductive to the tablet protective case 1. When the tablet 2 and tablet keyboard kit are used together, there are two use states: one of the two use states is to use only tablet protective case 1 to wrap the tablet 2, which uses daily to watch videos and play games to protect tablet 2; the other is that the tablet 2, the tablet protective case 1 and the integrated keyboard are used together, and the tablet protective case 1 and the integrated keyboard are conductive and interconnected, so that the tablet 2 and the integrated keyboard are conductive to each other.

The tablet keyboard kit provided in the present disclosure adopts the aforementioned tablet protective case 1, which includes a back plate 11, three edge plates 12, a conductive needle 13 and a fixing cover plate 14. The back plate 11 and three edge plates 12 are wrapped around the back and side surfaces of the tablet 2, the tablet protective case 1 is wrapped around the tablet 2 during daily use to protect the tablet 2. One side of the tablet 2 is exposed to facilitate magnetic coordination with the integrated keyboard to ensure normal typing on the keyboard. When the tablet 2 is used with the integrated keyboard, two ends of the conductive needle 13 are connected to the conductive portion 21 on the back of the tablet 2 and the conductive portion 21 on the support plate of the integrated keyboard respectively to realize the conducting between the tablet 2 and the integrated keyboard. In order to prevent the conductive needle 13 from falling off, one end of the conductive needle 13 is inserted into the connection hole 1111 of the back plate 11, and the fixing cover plate 14 is fixed on the skirt portion 133 and the back plate 11, so that the skirt portion 133 is sandwiched between the back plate 11 and the fixing cover plate 14, and the possibility of the conductive needle 13 falling off is reduced.

The aforementioned non-limiting embodiment or aspects are only preferred non-limiting embodiments or aspects of the present disclosure, and should not be regarded as being limitation to the present disclosure. Any modification, equivalent replacement, improvement, and so on, which are made within the spirit and the principle of the present disclosure, should be included in the protection scope of the present disclosure.

1. A tablet protective case, configured for wrapping a tablet and configured for being sandwiched between the tablet and a support plate of an integrated keyboard when in use, comprising:
a back plate;
three edge plates, respectively connected to three side edges of the back plate;
a conductive needle, configured for conducting the tablet and the integrated keyboard; and
a fixing cover plate;
wherein the back plate and the three edge plates are respectively configured for wrapping a back surface and side surfaces of the tablet, such that one of the side surfaces of the tablet is exposed to be in contact with the integrated keyboard; the back plate is provided with a connection hole and a sink groove arranged at a circumference of the connection hole, and a circumference of the conductive needle extends radially outward to form a skirt portion, an end of the conductive needle is inserted into the connection hole and configured for conducting with a conductive portion arranged on a back of the tablet, the skirt portion is located in the sink groove, and an other end of the conductive needle penetrates through the fixing cover plate, and the fixing cover plate is fixedly covered on the skirt portion and the back plate.

2. The tablet protective case according to the claim 1, wherein the fixing cover plate is ultrasonically connected or pasted to the back plate.

3. The tablet protective case according to the claim 1, wherein the back plate comprises a base plate and a decorative plate that are laminated, a side of the base plate facing away from the decorative plate is configured to closely fit with the tablet, the decorative plate is provided with an accommodating hole for accommodating the fixing cover plate, the sink groove and the connection hole are arranged on the base plate, and the sink groove and the connection hole are located in an area defined by the accommodating hole.

4. The tablet protective case according to the claim 3, wherein the base plate and the decorative plate are at least one of integrally formed and
separately formed and fixedly connected.

5. The tablet protective case according to the claim 1, wherein the conductive needle comprises a first conductive end and a second conductive end respectively located on two sides of the skirt portion; the fixing cover plate is provided with an avoidance hole, the first conductive end is arranged to be inserted into the connection hole, the second conductive end is arranged to be extended into the avoidance hole, and an end of the second conductive end away from the skirt portion is arranged flush with a side of the fixing cover plate.

6. The tablet protective case according to claim 5, wherein the first conductive end is connected with the connection hole in an interference fit.

7. The tablet protective case according to claim 5, wherein a diameter of the first conductive end is less than a diameter of the second conductive end.

8. The tablet protective case according to claim 1, wherein one of the edge plates is provided with a receiving groove for receiving a stylus.

9. The tablet protective case according to claim 8, wherein a bottom of the receiving groove is provided with an access hole to facilitate removing the stylus.

10. The tablet protective case according to claim 1, wherein the tablet protective case further comprises soft protective corners detachably connected to the edge plates, an end of one of the edge plates is provided with an accommodating groove and an insertion hole that are in communicated with each other, the accommodating groove is arranged along a length direction of the edge plate, one of the soft protective corners comprises an insertion portion configured for matching with the accommodating groove and a corner protective portion configured for matching with the insertion hole, the insertion portion and the corner protective portion are interconnected, the corner protective portion is protruded on an outer wall the edge plate, and a cross-sectional area of the insertion portion perpendicular to the length direction of the edge plate is greater than a cross-sectional area of the corner protective portion perpendicular to the length direction of the edge plate.

11. The tablet protective case according to claim 10, wherein the insertion portion comprises an arc unit and strip units that are interconnected, the corner protective portion is connected with the arc unit, and a length direction of the strip units is parallel to the length direction of the edge plate.

12. The tablet protective case according to claim 11, wherein the edge plate is provided with a key hole at a key right facing a mobile terminal, one of the strip units is configured to directly arrange facing the key, the strip unit is provided with a pressing hole penetrating through two sides of the insertion portion along a pressing direction of the key, the pressing hole is arranged facing the key hole, and an inner wall of the pressing hole is elastically connected with a pressing portion.

13. The tablet protective case according to claim 12, wherein two sides of the pressing portion are connected to the inner wall of the pressing hole by elastic walls.

14. The tablet protective case according to claim 10, wherein a side of the insertion portion is provided with a plurality of hollow portions

15. The tablet protective case according to claim 10, wherein a first step surface is formed at a joint of the corner protective portion and the insertion portion, a second step positioning surface is formed at a joint of the insertion hole and the accommodating groove, and the first step surface and the second step surface are arranged to be abutted against each other

16. The tablet protective case according to claim 10, wherein a portion where the corner protective portion is connected with the insertion portion is a root of the corner protective portion, a side of the corner protective portion away from the insertion portion is a top of the corner protective portion, and the corner protective portion gradually increases in size from the root to the top.

17. The tablet protective case according to claim 10, wherein an inner portion of the corner protective portion is hollow

18. The tablet protective case according to claim 10, wherein the corner protective portion and the insertion portion are integrally formed.

19. The tablet protective case according to claim 10, wherein one of the edge plates is provided with a receiving groove for receiving a stylus, and two ends of the edge plate are detachably connected with the soft protective corners.

20. A tablet keyboard kit, comprising: a tablet protective case and an integrated keyboard; the tablet protective case and the integrated keyboard are magnetically connected, and the integrated keyboard is mutually conductive to the tablet through a conductive needle:
wherein the tablet protective case is configured for wrapping a tablet and configured for being sandwiched between the tablet and a support plate of an integrated keyboard when is use, and comprises:
a back plate;
three edge plates, respectively connected to three side edges of the back plate;
a conductive needle, configured for conducting the tablet and the integrated keyboard, and
a fixing cover plate;
wherein the back plate and the three edge plates are respectively configured for wrapping a back a surface and side surfaces of the tablet, such that one of the side surfaces of the tablet is exposed to be contact with integrated keyboard; the back plate is provided with a connection hole and a sink groove arranged at a circumference of the connection hole, and a circumference of the conductive needle extends radially outward to form a skirt portion, an end of the conductive needle is inserted into the connection hole and configured for conducting with a conductive portion arranged on a back of the tablet, the skirt portion is located in the sink groove, and an other end of the conductive needle penetrates through the fixing cover plate, and the fixing cover plate is fixedly covered on the skirt portion and the back plate.
